(19) United States
(12) Patent Application Publication
(10) Pub. No.: US 2024/0396924 A1
(43) Pub. Date: Nov. 28, 2024

(54) A TOP-DOWN CYBER SECURITY SYSTEM AND METHOD

(71) Applicant: CyTwist LTD., Ramat Gan (IL)

(72) Inventors: Yehonadav HERTZ, Ramat Gan (IL); Yosef KORAKIN, Ramat Gan (IL)

(21) Appl. No.: 18/691,920

(22) PCT Filed: Mar. 22, 2022
(86) PCT No.: PCT/IL2022/050319

§ 371 Date: Mar. 14, 2024

Related U.S. Application Data
(60) Provisional application No. 63/243,751, filed on Sep. 14, 2021.

(51) Int. Cl. H04L 9/40

(52) U.S. Cl. CPC H04L 63/1433

(57) ABSTRACT

A cyber security system, the cyber security system comprising a processing circuitry configured to: obtain: (a) an attack-vector scenario, the attack-vector scenario comprising a sequence of cyber tactics, and (b) information about actual sequences of machine language instructions that executed on the one or more processors: identify, based on the information, the cyber techniques that occurred on the organizational network by matching the actual sequences of machine language instructions with the at least one sequence of machine language instructions associated with the cyber techniques, and alert a user of the cyber security system of a potential cyber-attack upon determining that each of the cyber tactics forming the attack vector scenario, is associated with at least one of the implemented cyber techniques.

### CROSS-REFERENCE TO RELATED APPLICATIONS

This application claims priority to U.S. Provisional Patent application No. 63/243,751, filed Sep. 14, 2021, which is incorporated by reference herein.

### TECHNICAL FIELD

The invention relates to a top-down cyber security system and method.

### BACKGROUND

Current cyber security systems operate by following a “bottom-up” scheme—they collect vast amounts of data relating to a pre-determined list of monitored events occurring on devices, network elements or any other endpoints of an organization. At least some of these endpoints are hosted on cloud-based computing platforms. The current cyber security systems monitor these pre-defined events, and upon one or more of the monitored events meeting certain rules—the events are reported to a central system for correlation analysis and in case some correlation criteria have been meet, for performing a response. In order to identify cyber-attacks, all events that can be related to an attack are collected and analyzed by these cyber security systems. This approach of collecting all indications from the endpoints (from the “bottom”) and moving them to the cyber security system for analysis (to the “up”) requires a large amount of organizational computation resources and results with false positive alerts. This approach disregards the vast amount of knowledge accumulated in the past years of how cyber-attacks are conducted. A non-limiting example is the MITRE ATT&CK framework, which is a free, globally accessible service that offers comprehensive and current knowledgebase of cyber security threat information. A cyber security system that will take advantage of these knowledgebases will be able to operate in a “top-down” scheme—examining events that may fit within a pattern of known cyber threats.

These current “bottom-up” cyber security systems rely on collection and analysis of events occurring on the application level of the endpoints of the organization. There is no collection and analysis of machine language instructions that are fetched and executed at the processor level of the endpoints. Machine language instructions are any low-level programming language, which are used to control a computer's CPU, GPU or other processors. Each instruction causes the processor to perform a very specific task, such as: a load, a store, a jump, or an Arithmetic Logic Unit (ALU) operation on one or more units of data in the processor's registers or memory. The machine language instructions can be fetched from a memory of the endpoint to one or more instruction units that are associated with one or more processors (such as: Central Processing Unit (CPU), Graphics Processing Unit (GPU), etc.) of the endpoint.

The lack of processor level indication is a loophole that can be exploited by attackers to hide their actions. An attacker can run a set of attack steps without generating events at the applicative level. Such an attack will go undetected by current cyber security systems which do not collect indication from the processor level.

Moreover, these current “bottom-up” cyber security systems rely on “abnormal” indications that occur on the endpoints and on the correlation of these “abnormal” indications. This mode-of-operation results in missing signs of cyber-attacks that are instituted by a series of “normal” machine language instructions that lead to a breach in the organizational network. A “top-down” approach based cyber security system will be able to analyze “normal” and “abnormal” machine language instructions as such a system will be guided by patterns of known cyber threats to select the relevant sequences of machine language instructions.

There is thus a need in the art for a new “top-down” approach to cyber security systems—a top-down cyber security system and method that takes advantage of the accumulated knowledgebase of cyber security threats to identify cyber-attacks within an organizational network based also on “normal” machine language instructions.

References considered to be relevant as background to the presently disclosed subject matter are listed below. Acknowledgement of the references herein is not to be inferred as meaning that these are in any way relevant to the patentability of the presently disclosed subject matter.

US Patent application No. 2020/0014713 (Paul et al.) published on Jan. 9, 2020, discloses a network management device generates a first script defining a first function for detecting a first customizable network event in a sequence of customizable network events indicative of a security threat to a network. The network management device activates the first script at a first network device in the network so as to cause the first network device to execute the first function for detecting the first customizable network event, and obtains, from the first network device, one or more indications that the first network device has detected the first customizable network event. Based on the one or more indications, the network management device determines whether to activate a second script defining a second function for detecting a second customizable network event in the sequence at a second network device in the network capable of detecting the second customizable network event.

US Patent application No. 2019/0141058 (Hassanzadeh et al.) published on May 9, 2019, discloses methods for detecting and identifying advanced persistent threats (APTs) in networks, including receiving first domain activity data from a first network domain and second domain activity data from a second network domain, including multiple alerts from the respective first and second network domains and where each alert of the multiple alerts results from one or more detected events in the respective first or second network domains. A classification determined for each alert of the multiple alerts with respect to a cyber kill chain. A dependency is then determined for each of one or more pairs of alerts and a graphical visualization of the multiple alerts is generated, where the graphical visualization includes multiple nodes and edges between the nodes, each node corresponding to the cyber kill chain and representing at least one alert, and each edge representing a dependency between alerts.

U.S. Pat. No. 10,033,748 (Cunningham et al.) published on Jul. 24, 2018, discloses a system and method to detect and contain threatening executable code by employing a threat monitor, verifier, endpoint agent, and a security information and event management module. The system and method determine whether a threat has persisted or executed, and allow that information to be communicated back to the detection mechanism (or other system) such that a user (or machine) may make a decision to take further action such as to contain the threat quickly and/or permit the system to do so automatically. The system further generates a report by a threat monitor, the report includes information on the one or more threats resulting from the analyzing of the portion of the network data; analyzing the information within the report by a verifier to yield intelligence that includes at least one of instructions or indicators related to the identified one or more threats and determining, gathering and correlating verification information from the endpoint agent to determine whether the verification information corresponds to a verified threat, the verification information includes at least a portion of the results of the examination and an identifier for the endpoint device; and sending a notification including a portion of the verification information to identify the verified threat.

US Patent application No. 2014/0344926 (Cunningham et al.) published on Nov. 20, 2014, discloses a system and method to detect and contain threatening executable code by employing a threat monitor, verifier, endpoint agent, and a security information and event management module.

U.S. Pat. No. 10,462,173 (Aziz et al.) published on Oct. 29, 2019, discloses techniques to determine and verify maliciousness of an object are described. An endpoint device, during normal processing of an object, identifies the object as suspicious in response to detected features of the object and coordinates further analysis with a malware detection system. The malware detection system processes the object, collects features related to processing, and analyzes the features of the suspicious object to classify as malicious or benign. Correlation of the features captured by the endpoint device and the malware detection system may verify a classification by the malware detection system of maliciousness of the content. The malware detection system may communicate with the one or more endpoint devices to influence detection and reporting of behaviors by those device(s).

US Patent application No. 2017/0063917 (CHESLA) published on Mar. 2, 2017, discloses a method and system for cyber threat risk-chain generation are provided. The method includes obtaining a plurality of events; mapping each event of the plurality of obtained events to a global threat type, wherein each global threat type is associated with a risk-chain group; correlating among the mapped plurality of events to determine at least a transition between one global threat type to another; and updating a data structure maintaining data of at least one risk-chain, when the transition is determined, wherein the at least one risk-chain is a lifecycle of a cyber-attack.

US Patent application No. 2018/0234435 (COHEN et al.) published on Aug. 16, 2018, discloses a cyber-security system and method for proactively predicting cyber-security threats are provided. The method comprises receiving a plurality of security events classified to different groups of events; correlating the plurality of received security events to classify potential cyber-security threats to a set of correlation types; determining a correlation score for each classified potential cyber-security threat; and determining a prediction score for each classified potential cyber-security threat, wherein the prediction score is determined based in part on the correlation score.

U.S. Pat. No. 9,654,485 (Neumann) published on May 16, 2017, discloses an analytics-based security monitoring system includes instructions that may be executed by a computing system to receive data in the form of event logs from one or more network devices transferred through a computing environment, detect a plurality of behavioral characteristics from the received event logs, identify behavioral fragments composed of related behavioral characteristics, and identify an attack by correlating the behavioral fragments against patterns of known malicious attacks. The analytics-based security monitoring system may then perform a learning process to enhance further detection of attacks and perform one or more remedial actions when an attack is identified.

US Patent application No. 2018/0351980 (GALULA et al.) published on Dec. 6, 2018, discloses a system and method for providing fleet cyber-security comprising may include collecting, by a plurality of data collection units installed in a respective plurality of vehicles in the fleet, information related to cyber security and including the information in reports to a server. Data in reports may be aggregated, by the server. A cyber-attack may be identified based on aggregated data.

U.S. Pat. No. 10,454,950 (Aziz) published on Oct. 22, 2019, discloses a centralized aggregation technique detects lateral movement of a stealthy (i.e., covert) cyber-attack in an enterprise network. A data center security (DCS) appliance may be located at a data center of the enterprise network, while a malware detection system (MDS) appliance may be located at a periphery of the network, an endpoint may be internally located within the enterprise network and an attack analyzer may be centrally located in the network. The appliances and endpoint may provide results of heuristics to an attack analyzer, wherein the heuristic results may be used to detect one or more tools downloaded to the endpoint, as well as resulting actions of the endpoint to determine whether the tools and actions manifest observable behaviors of the lateral movement of the SC-attack. The observable behaviors may include (i) unauthorized use of legitimate credentials obtained at the endpoint, as well as (ii) unusual access patterns via actions originated at the endpoint to acquire sensitive information stored on one or more servers on the network. The attack analyzer may then collect and analyze information related to the observable behaviors provided by the appliances and endpoint to create a holistic view of the lateral movement of the SC-attack.

### GENERAL DESCRIPTION

In accordance with a first aspect of the presently disclosed subject matter, there is provided a cyber security system, the cyber security system comprising a processing circuitry configured to: obtain: (a) an attack-vector scenario, the attack-vector scenario comprising a sequence of cyber tactics, each of the cyber tactics being associated with one or more respective cyber techniques which are possible manifestations of the corresponding cyber tactic in the context of the attack-vector scenario, at least one cyber technique is associated with at least one sequence of machine language instructions that can execute on one or more processors of at least one entity of a plurality of entities of an organizational network, wherein execution of the at least one sequence of machine language instructions indicates implementation of the respective cyber technique, and (b) information about actual sequences of machine language instructions that executed on the one or more processors; identify, based on the information, the cyber techniques that occurred on the organizational network by matching the actual sequences of machine language instructions with the at least one sequence of machine language instructions associated with the cyber techniques, giving rise to implemented cyber techniques; and alert a user of the cyber security system of a potential cyber-attack upon determining that each of the cyber tactics forming the attack vector scenario, is associated with at least one of the implemented cyber techniques.

In some cases, alerting the user of the potential cyber-attack is upon further determining that a causality connection exists between one or more of the implemented cyber techniques associated with each given cyber tactic of the cyber tactics and one or more of the implemented cyber techniques associated with a subsequent cyber tactic subsequent to the given cyber tactic, if any.

In some cases, the information about the actual sequences of machine language instructions is obtained by a trapping mechanism, capable of retrieving machine language instructions from an instruction unit, storing fetched machine learning instruction for at least one processor of the processors.

In some cases, (a) at least one machine language instruction of the sequence of machine language instructions comprises one or more first opcodes, and (b) the identification of the implemented cyber techniques is based on matching the opcodes comprised in the actual sequences of machine language instructions with second opcodes comprised in the at least one sequence of machine language instructions.

In some cases, the at least one sequence of machine language instructions is at least a partial translation of code realizing the corresponding cyber technique into machine langue instructions.

In some cases, the at least one sequence of machine language instructions includes one or more suspicious machine langue instructions, being machine learning instructions being a translation of suspicious code.

In some cases, (a) at least one cyber technique is associated with a corresponding event type of a plurality of event types that can occur on the one or more entities of the organizational network, wherein occurrence of an actual event of the respective event type indicates implementation of the respective cyber technique, (b) the information further includes actual events that occurred on the one or more entities of the organizational network, wherein each of the actual events is associated with a respective actual event type, and (c) the identification of the implemented cyber techniques is further based on matching the actual event types with the event types associated with the cyber techniques, giving rise to implemented cyber techniques.

In some cases, the information is obtained periodically or continuously and wherein the identify and the alert are performed periodically or continuously while maintaining previously identified implemented cyber techniques.

In some cases, the processing circuitry is further configured to: predict, based on: (a) the attack-vector scenario, (b) the implemented cyber techniques, and (c) the previously identified implemented cyber techniques, a next step cyber tactic of the cyber tactics; and perform a prevention action to prevent the next step cyber tactic.

In some cases, the prevention action is one or more of: (a) report the next step cyber tactic to the user of the cyber security system, (b) simulate the next step cyber tactic, or (c) implement one or more honeypots within one or more entities of the organizational network wherein events associated with the next step cyber tactic can occur.

In some cases, the actual events include at least one normal event that is not identified as abnormal.

In some cases, at least some of the information is obtained by an agent installed on a given entity of the entities.

In some cases, at least some of the information is retrieved by proactively querying a given entity of the entities.

In accordance with a second aspect of the presently disclosed subject matter, there is provided a method comprising: obtaining, by a processing circuitry: (a) an attack-vector scenario, the attack-vector scenario comprising a sequence of cyber tactics, each of the cyber tactics being associated with one or more respective cyber techniques which are possible manifestations of the corresponding cyber tactic in the context of the attack-vector scenario, at least one cyber technique is associated with at least one sequence of machine language instructions that can execute on one or more processors of at least one entity of a plurality of entities of an organizational network, wherein execution of the at least one sequence of machine language instructions indicates implementation of the respective cyber technique, and (b) information about actual sequences of machine language instructions that executed on the one or more processors; identifying, by the processing circuitry, based on the information, the cyber techniques that occurred on the organizational network by matching the actual sequences of machine language instructions with the at least one sequence of machine language instructions associated with the cyber techniques, giving rise to implemented cyber techniques; and alerting, by the processing circuitry, a user of the cyber security system of a potential cyber-attack upon determining that each of the cyber tactics forming the attack vector scenario, is associated with at least one of the implemented cyber techniques.

In some cases, alerting the user of the potential cyber-attack is upon further determining that a causality connection exists between one or more of the implemented cyber techniques associated with each given cyber tactic of the cyber tactics and one or more of the implemented cyber techniques associated with a subsequent cyber tactic subsequent to the given cyber tactic, if any.

In some cases, the information about the actual sequences of machine language instructions is obtained by a trapping mechanism, capable of retrieving machine language instructions from an instruction unit, storing fetched machine learning instruction for at least one processor of the processors.

In some cases, (a) at least one machine language instruction of the sequence of machine language instructions comprises one or more first opcodes, and (b) the identification of the implemented cyber techniques is based on matching the opcodes comprised in the actual sequences of machine language instructions with second opcodes comprised in the at least one sequence of machine language instructions.

In some cases, at least one sequence of machine language instructions is at least a partial translation of code realizing the corresponding cyber technique into machine langue instructions.

In some cases, the at least one sequence of machine language instructions includes one or more suspicious machine langue instructions, being machine learning instructions being a translation of suspicious code.

In some cases, (a) at least one cyber technique is associated with a corresponding event type of a plurality of event types that can occur on the one or more entities of the organizational network, wherein occurrence of an actual event of the respective event type indicates implementation of the respective cyber technique. (b) the information further includes actual events that occurred on the one or more entities of the organizational network, wherein each of the actual events is associated with a respective actual event type, and (c) the identification of the implemented cyber techniques is further based on matching the actual event types with the event types associated with the cyber techniques, giving rise to implemented cyber techniques.

In some cases, the information is obtained periodically or continuously and wherein the identify and the alert are performed periodically or continuously while maintaining previously identified implemented cyber techniques.

In some cases, the method further comprising: predicting, by the processing circuitry, based on: (a) the attack-vector scenario, (b) the implemented cyber techniques, and (c) the previously identified implemented cyber techniques, a next step cyber tactic of the cyber tactics; and performing, by the processing circuitry, a prevention action to prevent the next step cyber tactic.

In some cases, the prevention action is one or more of: (a) report the next step cyber tactic to the user of the cyber security system, (b) simulate the next step cyber tactic, or (c) implement one or more honeypots within one or more entities of the organizational network wherein events associated with the next step cyber tactic can occur.

In some cases, the actual events include at least one normal event that is not identified as abnormal.

In some cases, at least some of the information is obtained by an agent installed on a given entity of the entities.

In some cases, at least some of the information is retrieved by proactively querying a given entity of the entities.

In accordance with a third aspect of the presently disclosed subject matter, there is provided a non-transitory computer readable storage medium having computer readable program code embodied therewith, the computer readable program code, executable by at least one processing circuitry of a computer to perform a method of: obtaining, by a processing circuitry: (a) an attack-vector scenario, the attack-vector scenario comprising a sequence of cyber tactics, each of the cyber tactics being associated with one or more respective cyber techniques which are possible manifestations of the corresponding cyber tactic in the context of the attack-vector scenario, at least one cyber technique is associated with at least one sequence of machine language instructions that can execute on one or more processors of at least one entity of a plurality of entities of an organizational network, wherein execution of the at least one sequence of machine language instructions indicates implementation of the respective cyber technique, and (b) information about actual sequences of machine language instructions that executed on the one or more processors; identifying, by the processing circuitry, based on the information, the cyber techniques that occurred on the organizational network by matching the actual sequences of machine language instructions with the at least one sequence of machine language instructions associated with the cyber techniques, giving rise to implemented cyber techniques; and alerting, by the processing circuitry, a user of the cyber security system of a potential cyber-attack upon determining that each of the cyber tactics forming the attack vector scenario, is associated with at least one of the implemented cyber techniques.

In accordance with a fourth aspect of the presently disclosed subject matter, there is provided a cyber security system, the cyber security system comprising a processing circuitry configured to: obtain: (a) an attack-vector scenario, the attack-vector scenario comprising a sequence of cyber tactics, each of the cyber tactics being associated with one or more respective cyber techniques which are possible manifestations of the corresponding cyber tactic in the context of the attack-vector scenario, each cyber technique is associated with a corresponding event type of a plurality of event types that can occur on one or more entities of an organizational network, wherein occurrence of an actual event of the respective event type indicates implementation of the respective cyber technique, and (b) information about actual events that occurred on the one or more entities of the organizational network, wherein each of the actual events is associated with a respective actual event type; identify, based on the information, the cyber techniques that occurred on the organizational network by matching the actual event types with the event types associated with the cyber techniques, giving rise to implemented cyber techniques; and alert a user of the cyber security system of a potential cyber-attack upon determining that alert requirements being met, the alert requirements including that: (a) each of the cyber tactics forming the attack vector scenario, is associated with at least one of the implemented cyber techniques, and (b) each pair of implemented cyber techniques associated with a pair of subsequent cyber tactics is associated with a respective common property.

In some cases, the alert requirements further include that at least two of the implemented cyber techniques meet a validation rule validating at least a part of the attack-vector scenario.

In some cases, the validation is based on one or more properties of each of the at least two of the implemented cyber techniques.

In some cases, the information is obtained periodically or continuously and wherein the identify and the alert are performed periodically or continuously while maintaining previously identified implemented cyber techniques.

In some cases, the processing circuitry is further configured to: predict, based on: (a) the attack-vector scenario, (b) the implemented cyber techniques, and (c) the previously identified implemented cyber techniques, a next step cyber tactic of the cyber tactics; and perform a prevention action to prevent the next step cyber tactic.

In some cases, the prevention action is one or more of: (a) report the next step cyber tactic to the user of the cyber security system, (b) simulate the next step cyber tactic, or (c) implement one or more honeypots within one or more entities of the organizational network wherein events associated with the next step cyber tactic can occur.

In some cases, the actual events include at least one normal event that is not identified as abnormal.

In some cases, at least some of the information is obtained by an agent installed on a given entity of the entities.

In some cases, at least some of the information is retrieved by proactively querying a given entity of the entities.

In accordance with a fifth aspect of the presently disclosed subject matter, there is provided a cyber security method, the cyber security method comprising: obtaining, by a processing circuitry: (a) an attack-vector scenario, the attack-vector scenario comprising a sequence of cyber tactics, each of the cyber tactics being associated with one or more respective cyber techniques which are possible manifestations of the corresponding cyber tactic in the context of the attack-vector scenario, each cyber technique is associated with a corresponding event type of a plurality of event types that can occur on one or more entities of an organizational network, wherein occurrence of an actual event of the respective event type indicates implementation of the respective cyber technique, and (b) information about actual events that occurred on the one or more entities of the organizational network, wherein each of the actual events is associated with a respective actual event type; identifying, by the processing circuitry, based on the information, the cyber techniques that occurred on the organizational network by matching the actual event types with the event types associated with the cyber techniques, giving rise to implemented cyber techniques; and alerting, by the processing circuitry, a user of the cyber security system of a potential cyber-attack upon determining that alert requirements being met, the alert requirements including that: (a) each of the cyber tactics forming the attack vector scenario, is associated with at least one of the implemented cyber techniques, and (b) each pair of implemented cyber techniques associated with a pair of subsequent cyber tactics is associated with a respective common property.

In some cases, the alert requirements further include that at least two of the implemented cyber techniques meet a validation rule validating at least a part of the attack-vector scenario.

In some cases, the validation is based on one or more properties of each of the at least two of the implemented cyber techniques.

In some cases, the information is obtained periodically or continuously and wherein the identify and the alert are performed periodically or continuously while maintaining previously identified implemented cyber techniques.

In some cases, the method further comprising: predicting, by the processing circuitry, based on: (a) the attack-vector scenario, (b) the implemented cyber techniques, and (c) the previously identified implemented cyber techniques, a next step cyber tactic of the cyber tactics; and performing, by the processing circuitry, a prevention action to prevent the next step cyber tactic.

In some cases, the prevention action is one or more of: (a) report the next step cyber tactic to the user of the cyber security system, (b) simulate the next step cyber tactic, or (c) implement one or more honeypots within one or more entities of the organizational network wherein events associated with the next step cyber tactic can occur.

In some cases, the actual events include at least one normal event that is not identified as abnormal.

In some cases, at least some of the information is obtained by an agent installed on a given entity of the entities.

In some cases, at least some of the information is retrieved by proactively querying a given entity of the entities.

In accordance with a sixth aspect of the presently disclosed subject matter, there is provided a non-transitory computer readable storage medium having computer readable program code embodied therewith, the computer readable program code, executable by at least one processor of a computer to perform a method of: obtaining, by a processing circuitry: (a) an attack-vector scenario, the attack-vector scenario comprising a sequence of cyber tactics, each of the cyber tactics being associated with one or more respective cyber techniques which are possible manifestations of the corresponding cyber tactic in the context of the attack-vector scenario, each cyber technique is associated with a corresponding event type of a plurality of event types that can occur on one or more entities of an organizational network, wherein occurrence of an actual event of the respective event type indicates implementation of the respective cyber technique, and (b) information about actual events that occurred on the one or more entities of the organizational network, wherein each of the actual events is associated with a respective actual event type; identifying, by the processing circuitry, based on the information, the cyber techniques that occurred on the organizational network by matching the actual event types with the event types associated with the cyber techniques, giving rise to implemented cyber techniques; and alerting, by the processing circuitry, a user of the cyber security system of a potential cyber-attack upon determining that alert requirements being met, the alert requirements including that: (a) each of the cyber tactics forming the attack vector scenario, is associated with at least one of the implemented cyber techniques, and (b) each pair of implemented cyber techniques associated with a pair of subsequent cyber tactics is associated with a respective common property.

### BRIEF DESCRIPTION OF THE DRAWINGS

In order to understand the presently disclosed subject matter and to see how it may be carried out in practice, the subject matter will now be described, by way of non-limiting examples only, with reference to the accompanying drawings, in which:

FIG. 1 is a schematic illustration of an example attack-vector scenario, in accordance with the presently disclosed subject matter;

FIG. 2 is a block diagram schematically illustrating one example of a top-down cyber security system, in accordance with the presently disclosed subject matter;

FIG. 3 is a flowchart illustrating one example of a sequence of operations carried out for a top-down cyber-attack identification by identifying execution of one or more sequence of machine language instructions, in accordance with the presently disclosed subject matter; and

FIG. 4 is a flowchart illustrating one example of a sequence of operations carried out for a top-down cyber-attack identification by identifying occurrence of one or more event types, in accordance with the presently disclosed subject matter.

### DETAILED DESCRIPTION

In the following detailed description, numerous specific details are set forth in order to provide a thorough understanding of the presently disclosed subject matter. However, it will be understood by those skilled in the art that the presently disclosed subject matter may be practiced without these specific details. In other instances, well-known methods, procedures, and components have not been described in detail so as not to obscure the presently disclosed subject matter.

In the drawings and descriptions set forth, identical reference numerals indicate those components that are common to different embodiments or configurations.

Unless specifically stated otherwise, as apparent from the following discussions, it is appreciated that throughout the specification discussions utilizing terms such as “obtaining”, “collecting”. “identifying”, “alerting”. “predicting”. “performing”, “analyzing”, “triggering”, “negating”, “canceling”, “fetching”, “executing” or the like, include action and/or processes of a computer that manipulate and/or transform data into other data, said data represented as physical quantities, e.g., such as electronic quantities, and/or said data representing the physical objects. The terms “computer”, “processor”, “processing resource”, “processing circuitry” and “controller” should be expansively construed to cover any kind of electronic device with data processing capabilities, including, by way of non-limiting example, a personal desktop/laptop computer, a server, a computing system, a communication device, a smartphone, a tablet computer, a smart television, a processor (e.g. digital signal processor (DSP), a microcontroller, a field programmable gate array (FPGA), an application specific integrated circuit (ASIC), etc.), a group of multiple physical machines sharing performance of various tasks, virtual servers co-residing on a single physical machine, any other electronic computing device, and/or any combination thereof.

The operations in accordance with the teachings herein may be performed by a computer specially constructed for the desired purposes or by a general-purpose computer specially configured for the desired purpose by a computer program stored in a non-transitory computer readable storage medium. The term “non-transitory” is used herein to exclude transitory, propagating signals, but to otherwise include any volatile or non-volatile computer memory technology suitable to the application.

As used herein, the phrase “for example,” “such as”, “for instance” and variants thereof describe non-limiting embodiments of the presently disclosed subject matter. Reference in the specification to “one case”, “some cases”, “other cases” or variants thereof means that a particular feature, structure or characteristic described in connection with the embodiment(s) is included in at least one embodiment of the presently disclosed subject matter. Thus, the appearance of the phrase “one case”, “some cases”, “other cases” or variants thereof does not necessarily refer to the same embodiment(s).

It is appreciated that, unless specifically stated otherwise, certain features of the presently disclosed subject matter, which are, for clarity, described in the context of separate embodiments, may also be provided in combination in a single embodiment. Conversely, various features of the presently disclosed subject matter, which are, for brevity, described in the context of a single embodiment, may also be provided separately or in any suitable sub-combination.

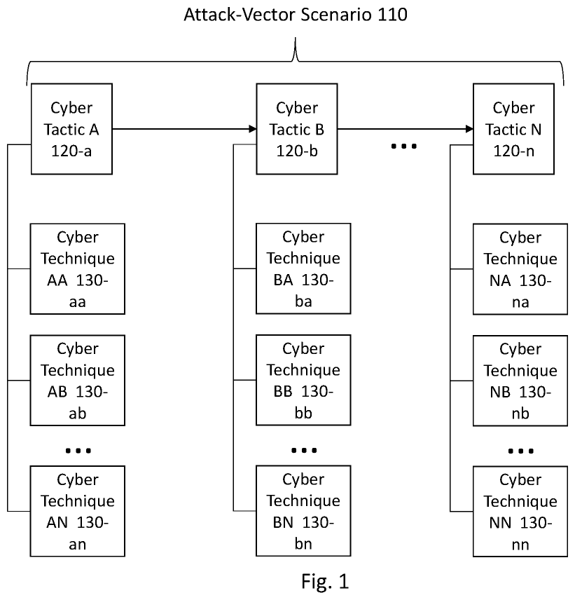

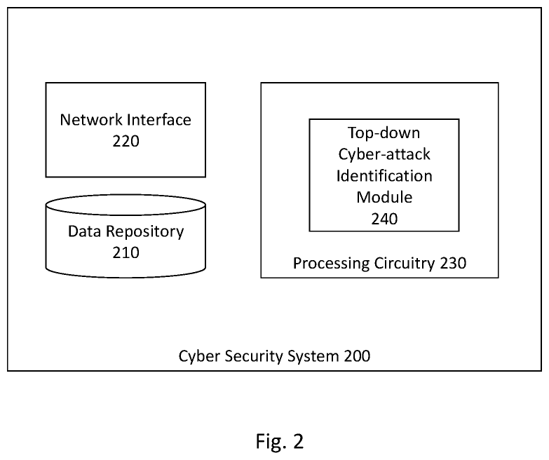

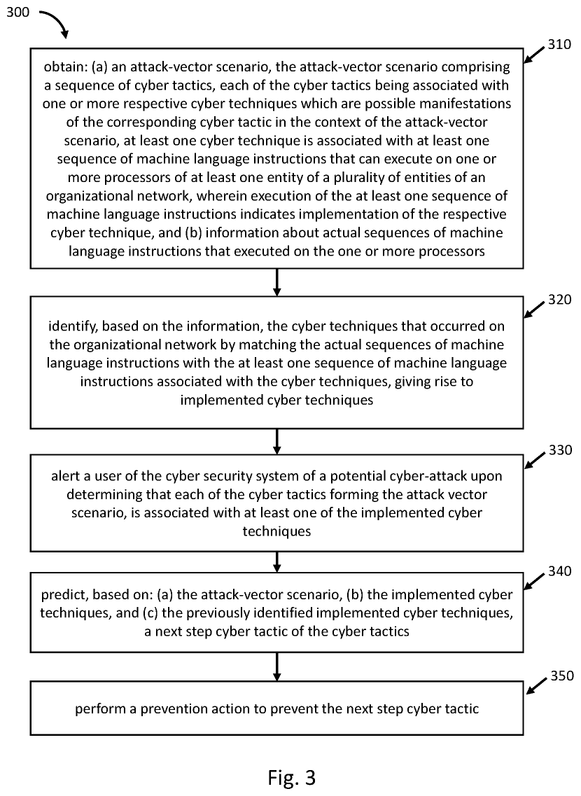

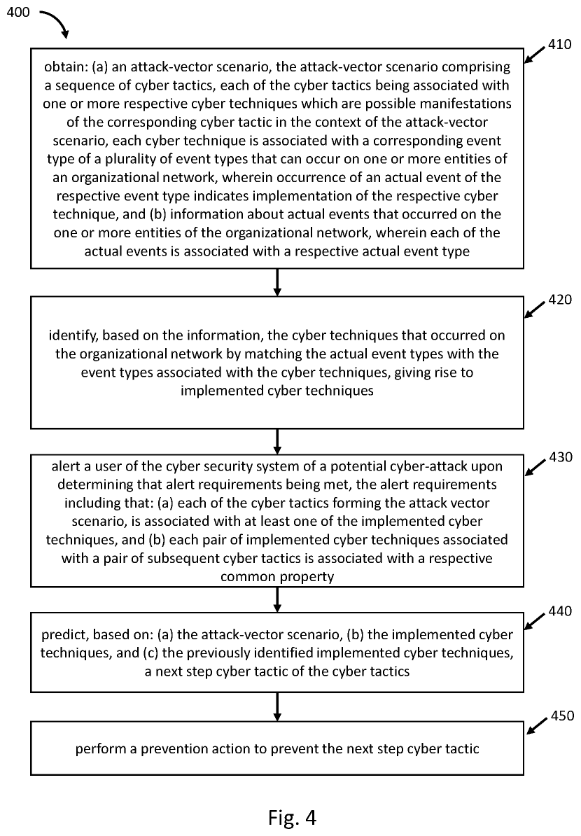

In embodiments of the presently disclosed subject matter, fewer, more and/or different stages than those shown in FIGS. 3-4 may be executed. In embodiments of the presently disclosed subject matter one or more stages illustrated in FIGS. 3-4 may be executed in a different order and/or one or more groups of stages may be executed simultaneously. FIGS. 1-2 illustrate a general schematic of the system architecture in accordance with an embodiment of the presently disclosed subject matter. Each module in FIGS. 1-2 can be made up of any combination of software, hardware and/or firmware that performs the functions as defined and explained herein. The modules in FIGS. 1-2 may be centralized in one location or dispersed over more than one location. In other embodiments of the presently disclosed subject matter, the system may comprise fewer, more, and/or different modules than those shown in FIGS. 1-2.

Any reference in the specification to a method should be applied mutatis mutandis to a system capable of executing the method and should be applied mutatis mutandis to a non-transitory computer readable medium that stores instructions that once executed by a computer result in the execution of the method.

Any reference in the specification to a system should be applied mutatis mutandis to a method that may be executed by the system and should be applied mutatis mutandis to a non-transitory computer readable medium that stores instructions that may be executed by the system.

Any reference in the specification to a non-transitory computer readable medium should be applied mutatis mutandis to a system capable of executing the instructions stored in the non-transitory computer readable medium and should be applied mutatis mutandis to method that may be executed by a computer that reads the instructions stored in the non-transitory computer readable medium.

Please note that the terms “cyber security system” and “top-down” cyber security system” are used herein interchangeably.

Bearing this in mind, attention is drawn to FIG. 1, is a schematic illustration of an example attack-vector scenario, in accordance with the presently disclosed subject matter.

An attack-vector scenario 110 is a sequence of steps taken by an adversary to attack an organizational network. The attack-vector scenario 110 is associated with a sequence of cyber tactics (e.g., cyber tactic A 120-a, cyber tactic B 120-b, . . . , cyber tactic N 120-n). Each cyber tactic embodies a logical step within the respective attack-vector scenario. Each cyber tactic represents the “why” behind the adversary's cyber-attack action. Each cyber tactic describes what the adversary is trying to accomplish in that step. In general, the cyber tactic represents the tactical objective and the reason behind the cyber-attack action of the adversary. The cyber tactic is the adversary's tactical goal: the reason for performing that certain cyber-attack action as part of the attack vector scenario 110. A non-limiting example of an attack-vector scenario 110 and its associated cyber tactics can be a persistence attack-vector scenario 110. In this attack-vector scenario 110 the adversary wants to discover credential information within the attacked organizational network and use these discovered credentials to stay persistent within systems of the attacked organizational network. The persistence attack-vector scenario 110 can be associated with a sequence of two cyber tactics: discovery cyber tactic and persistence cyber tactic. The goal of the discovery cyber tactic is to discover credential and the goal of the persistence cyber tactic is to use the discovered credentials to stay persistent within the systems.

Each cyber tactic is associated with one or more respective cyber techniques (e.g., cyber technique AA 130-aa, cyber technique AB 130-ab, . . . , cyber technique AN 130-an, cyber technique BA 130-ba, cyber technique BB 130-bb, . . . , cyber technique BN 130-bn, cyber technique AN 130-an, cyber technique NA 130-na, cyber technique NB 130-nb . . . , cyber technique NN 130-nn). Each cyber technique represents “how” an adversary achieves a tactical goal of the corresponding cyber tactic by performing a cyber-attack action. Each cyber technique is a possible manifestation of the corresponding cyber tactic in the context of the attack-vector scenario 110. Continuing the above non-limiting example of a persistence attack-vector scenario 110 and its two associated cyber tactics: discovery cyber tactic and persistence cyber tactic. The discovery cyber tactic can be associated with one or more cyber techniques. For example, with a file and directory discovery cyber technique, where adversaries enumerate files and directories within systems of the attacked organizational network or may search within specific locations of the attacked organizational network share for certain information within a file system. Adversaries may use the information gathered by the file and directory discovery cyber technique during follow-on cyber tactics. Another non-limiting example of a cyber technique that can be associated with the discovery cyber tactic is a software discovery cyber technique, where adversaries attempt to get a listing of software and software versions that are installed on one or more systems of the attacked organizational network. Adversaries may use the information gathered by the software discovery cyber technique during follow-on cyber tactics. The persistence cyber tactic can be associated with one or more cyber techniques. For example, with a create account cyber technique, where adversaries create an account to maintain access to systems of the attacked organizational network. With a sufficient level of access, creating such accounts can be used to establish secondary credentialed access that do not require persistent remote access tools to be deployed on the systems of the attacked organizational network. Another non-limiting example of a cyber technique that can be associated with the persistent cyber tactic is a hijack execution flow cyber technique, where adversaries execute their own malicious payloads by hijacking the way operating systems installed on systems of the attacked organizational network run programs. Hijacking execution flow cyber technique can be used for the purposes of persistence, since this hijacked execution may reoccur over time.

In some cases, one or more given cyber techniques of the cyber techniques can be comprised of one or more sub-techniques, which are a more specific description of the adversarial behavior used to achieve the goal of the corresponding cyber tactic. The sub-techniques describe behavior at a lower level than a technique.

At least one cyber technique is associated with at least one sequence of machine language instructions that can execute on one or more processors of at least one entity of a plurality of entities of an organizational network, wherein execution of the at least one sequence of machine language instructions indicates implementation of the respective cyber technique. Machine language instructions are any low-level programming language, which are used to control a computer's CPU, GPU or other processors. Each instruction causes the processor to perform a very specific task, such as: a load, a store, a jump, or an Arithmetic Logic Unit (ALU) operation on one or more units of data in the processor's registers or memory. Machine language instructions can be a strictly numerical language which is designed to run as fast as possible. Machine language instructions are the lowest-level representation of a compiled or assembled computer program. The sequences of machine language instruction associated with a given cyber technique are an implementation of at least part of the given cyber technique. The given cyber technique can be realized in a number of ways, for example: by executing one or more corresponding computer programs that implements the given cyber technique. The sequences of machine language instructions are at least a partial translation of one or more of the corresponding computer programs. When one of these sequences is observed as being fetched and/or executed on a processor of an entity—the corresponding cyber technique has been implemented on that entity within the organizational network. For example: the create account cyber technique, discussed above, where adversaries create an account to maintain access to systems of the attacked organizational network, can be realized by one or more create account computer programs, each implementing the create account cyber technique in a different way. When the create account computer program executes on one or more of the entities, the create account cyber technique is realized and thus implemented within the organizational network. Each create account computer program can be translated into one or more sequence of machine language instructions. These sequences of machine language instructions are associated with the create account cyber technique. When one of these sequences is observed as being fetched and/or executed on a processor of an entity—the create account cyber technique has been implemented on that entity.

The sequences of machine language instructions can be determined manually or automatically as associated with a given cyber technique, for example: by utilizing a Machine Learning (ML) model capable of receiving a sequence of machine language instructions and classifying it as associated with the given cyber technique.

In some cases, the at least one sequence of machine language instructions is at least a partial translation of code of a given computer program, that realizes the corresponding cyber technique, into machine langue instructions. The translation can be determined manually or automatically, for example: by utilizing a ML model capable of receiving a sequence of machine language instructions and classifying it as a translation of the given computer program. In some cases, the translation is a partial translation—where not all lines of code comprised within the computer program are translated in the sequence of machine language instructions. For example: a given create account computer program has ten lines of code. The program that is translated into a sequence of machine language instructions can include hundreds of machine language instructions. A partial translation can be a translation of just one or more of these lines of code into machine language instructions. When the partial translation sequence is observed as being fetched and/or executed on a processor of an entity—the create account computer program has been executed and thus the cyber technique has been implemented on that entity. The translation can be of as specific line of code that performs a given operation—for example: accessing a certain address in memory. Observing a sequence of machine language instructions that access that certain address is an indication that the cyber technique has been implemented. The given operation can be suspicious code that can be an indication for a malicious operation, for example: code that access a restricted or protected area of the memory. Suspicious machine langue instructions are machine learning instructions that comprise a translation of suspicious code. Fetching and/or execution of suspicious machine langue instructions is an indication of the implementation of the corresponding cyber technique.

The computer programs can be determined manually or automatically as associated with a given cyber technique, for example: by utilizing a ML model capable of receiving a computer program and classifying it as associated with the given cyber technique.

The information about the actual sequences of machine language instructions that are fetched and/or executed on the entities, can be obtained by a trapping mechanism, capable of retrieving machine language instructions from an instruction unit, storing fetched machine learning instruction for at least one processor of the processors. The trapping can be done at the CPU level of each of the entities.

It is to be noted that at least one machine language instruction of the sequence of machine language instructions comprises one or more first opcodes, being the portion of the machine language instruction that specifies the operation to be performed. In some cases, the identification of the implemented cyber techniques is based on matching the opcodes comprised in the actual sequences of machine language instructions with the opcodes comprised in the at least one sequence of machine language instructions. In these cases, the identification does not rely on other parts of the machine language instruction, such as: operands, only on the opcodes part of the machine language instructions.

Continuing our non-limiting example above, the file and directory discovery cyber technique can be associated with one or more sequences of machine language instructions, one of which can be a translation of a computer program for executing a “dir” command on a command line of a computer of the attacked organizational network. Execution of the actual sequence of machine language instructions for a “dir” command on a processor of an entity of the attacked organizational network indicates implementation of the respective cyber technique. For example, information about an actual execution of the “dir” command on a command line of a computer of the attacked organizational network is an indication of an implementation of the file and directory discovery cyber technique within the attacked organizational network. Each actual sequence of machine language instructions can have one or more properties associated with the actual sequence of machine language instructions. For example, the actual sequence of machine language instructions for execution of the “dir” command on a command line of a computer of the attacked organizational network can have properties of: parameters of the command, the name and address of the computer where the command was executed, the date and time of the command execution, the results of the command execution and other property associated with the actual sequence of machine language instructions. Continuing another non-limiting example above, the hijack execution flow cyber technique can be associated with one or more sequences of machine language instructions, one of which can be an adversary using a windows operating system backdoor to replace the nonexistent windows Dynamic-Link Library (DLL) “msftc.dll” with its own malicious version, which will be loaded as part of the routine flow of the operating system to hijack the execution flow. An actual sequence of machine language instructions for replacing the “msfte.dll” on a specific endpoint of the attacked organizational network is an indication of an implementation of the hijack execution flow cyber technique within the attacked organizational network.

Identifying cyber techniques that actually occurred on the attacked organizational network can be achieved by matching the sequences of machine language instructions associated with the cyber techniques with the actual sequences of machine language instructions fetched and/or executed on one or more entities of the attacked organizational network. A given cyber tactic has occurred within the attacked organizational network when one or more of the cyber techniques associated with the given cyber tactic become implemented cyber techniques. When each of the cyber tactics forming the attack-vector scenario 110, is associated with at least one of the implemented cyber techniques the attack-vector scenario 110 has occurred within the attacked organizational network.

At least one cyber technique can be associated with one or more event types that can occur on one or more entities of the attacked organizational network. In some cases, a given cyber technique is associated with the at least one sequence of machine language instructions and with the one or more events. In other cases, a first cyber technique of attack-vector scenario 110 is associated with the at least one sequence of machine language instructions and a second cyber technique of attack-vector scenario 110 is associated with the one or more events. Each entity can be an asset of the attacked organization. An asset can be: systems, computerized devices (such as: endpoint computers, smart mobile devices, servers, etc.), network elements (such as: firewalls, routers, switches, etc.), physical assets (such as: human workers of the organization, visitors to the organization, rooms, doors, air-conditioning systems, etc.) or any other asset of the organization. In some cases, one or more of the entities of the attacked organizational network are installed on one or more cloud computing platforms. For example, some of the systems of the organizational network can be implemented as serverless functions running on a cloud computing platform. In some cases, one or more of the assets of the attacked organizational network can be Internet of Things (IoT) endpoints. For example, the asset can be an IoT controller, controlling the locking and unlocking of doors within the organization.

Continuing our non-limiting example above, the file and directory discovery cyber technique can be associated with one or more event types, one of which can be an event type of executing a “dir” command on a command line of a computer of the attacked organizational network. Occurrence of an actual event of the respective event type on an entity of the attacked organizational network indicates implementation of the respective cyber technique. For example, information about an actual event of execution of a “dir” command on a command line of a computer of the attacked organizational network is an indication of an implementation of the file and directory discovery cyber technique within the attacked organizational network. Each actual event can have one or more properties associated with the actual event. For example, the actual event of execution of a “dir” command on a command line of a computer of the attacked organizational network can have properties of: parameters of the command, the name and address of the computer where the command was executed, the date and time of the command execution, the results of the command execution and other property associated with the actual event. Continuing another non-limiting example above, the hijack execution flow cyber technique can be associated with one or more event types, one of which can be an event type of “Denis”, which is a windows operating system backdoor. An adversary using “Denis” can replace the nonexistent windows Dynamic-Link Library (DLL) “msfte.dll” with its own malicious version, which will be loaded as part of the routine flow of the operating system to hijack the execution flow. An actual event of replacing the “msfte.dll” on a specific endpoint of the attacked organizational network is an indication of an implementation of the hijack execution flow cyber technique within the attacked organizational network.

Identifying cyber techniques that actually occurred on the attacked organizational network can be achieved by matching the event types of the actual events with the event types associated with the cyber techniques. These are implemented cyber techniques within the attacked organizational network. A given cyber tactic has occurred within the attacked organizational network when one or more of the cyber techniques associated with the given cyber tactic become implemented cyber techniques. When each of the cyber tactics forming the attack-vector scenario 110, is associated with at least one of the implemented cyber techniques the attack-vector scenario 110 has occurred within the attacked organizational network.

In some cases, in supplement to the occurrence of the cyber tactics forming the attack-vector scenario 110 an existence of a common property associated with each pair of implemented cyber techniques, which are associated with a pair of subsequent cyber tactics. The common properties can be the same between some or all of the pairs. In some cases, the common properties are different for each pair of implemented cyber techniques. The common properties between each of the pairs create a relation chain between the implemented cyber techniques, this chain is in the context of the adversary who is trying to perpetrate the attack-vector scenario 110 within the attacked organizational network. In the eyes of the attacker there is a logic for executing a second cyber tactic (using a second given implemented cyber technique) after a first cyber tactic (that have been executed using a first given implemented cyber technique), because the is a common relation between the first and second cyber tactics that has been manifested through the common property between the first given implemented cyber technique and the second given implemented cyber technique. The common property can be found in one or more dimensions of the implemented cyber techniques. For example: time dimension—the implemented cyber techniques occurred within a predefined time window, location dimension—the implemented cyber techniques occurred within one or more entities of the attacked organizational network having a connection between them, cyber tool dimension—the cyber tools used for executing the implemented cyber techniques are the same, and any other dimension of the implemented cyber techniques and their properties. The common property connection can be checked between pairs of implemented cyber techniques that are associated with subsequent cyber tactics of the attack-vector scenario 110. The common property contention can be deduced based on the actual events, and their properties, of the evet type associated with the one or more implemented cyber techniques that are associated with one or more of the cyber tactics comprising the attack-vector scenario 110. The common property contention analysis can be done of tuples of implemented cyber techniques and the information associated with them. The common property contention analysis can be based on: machine learning, one or more rule sets, experts' knowledgebase or any other method to identify common properties between two or more cyber techniques. The analysis can be in the context of the attack-vector scenario 110 and the results of the analysis can be different for different attack-vector scenarios 110.

Continuing our example above of the persistence attack-vector scenario 110 and its two associated cyber tactics: discovery cyber tactic and persistence cyber tactic. Information about actual events that occurred on the one or more entities of the organizational network can include, for example, the occurrence of an actual event of execution of a “dir” command, can be seen as an indication of implementation of the file and directory discovery cyber technique, which means that the discovery cyber tactic has occurred and the occurrence of an actual event of replacement of the “msfte.dll” DLL file, can be seen as an indication of implementation of the hijack execution flow cyber technique, which means that the persistence cyber tactic has occurred. As both tactics of the persistence attack-vector scenario 110 have occurred, we can optionally check for a common property connection between the actual events. In our non-limiting example, a rule-set is used to analyze the relevant actual events and their properties to find that there is a casual connection, for example the date and time of both actual events are within a predefined time window, so there is an indication of occurrence of the persistence attack-vector scenario 110 within the attacked organizational network.

A top-down cyber security system applies a “top-down” approach to cyber security utilizing one or more attack-vector scenarios 110 and information about actual events that occurred on the one or more entities of the attacked organizational network, to alert a user of the cyber security system of a potential cyber-attack, as further detailed herein, inter alia with reference to FIGS. 3 and 4.

This top-down cyber security system is more efficient than current cyber security systems as it requires monitoring of fewer events and results in less false positive alerts.

Having briefly described an attack-vector scenario, attention is drawn to FIG. 2, a block diagram schematically illustrating one example of a top-down cyber security system, in accordance with the presently disclosed subject matter.

According to certain examples of the presently disclosed subject matter, a cyber security system 200 comprises a network interface 220 enabling connecting the cyber security system 200 to an organizational network and enabling it to send and receive data sent thereto through the organizational network, including in some cases receiving information collected from computerized endpoints of the organizational network and specifically information trapped and fetched from their processors and from their respective instruction units. In some cases, the network interface 220 can be connected to the Internet.

In some cases, at least part of cyber security system 200 can be installed on one or more cloud computing platforms. For example, as a serverless function running on a cloud platform. In some cases, at least part of the organizational network is installed on one or more cloud computing platforms.

Cyber security system 200 can further comprise or be otherwise associated with a data repository 210 (e.g., a database, a storage system, a memory including Read Only Memory—ROM, Random Access Memory—RAM, or any other type of memory, etc.) configured to store data, including, inter alia, one or more attack-vector scenarios 110, sequences of cyber tactics (e.g., cyber tactic A 120-a, cyber tactic B 120-b, . . . , cyber tactic N 120-n) associated with one or more of the attack-vector scenarios 110, cyber techniques (e.g., cyber technique AA 130-aa, cyber technique AB 130-ab, . . . , cyber technique AN 130-an, cyber technique BA 130-ba, cyber technique BB 130-bb, cyber technique BN 130-bn, cyber technique AN 130-an, cyber technique NA 130-na, cyber technique NB 130-nb, . . . , cyber technique NN 130-nn) associated with one or more of the cyber tactics, information about actual sequences of machine language instructions that executed on the one or more processors, information about actual events that occurred on one or more entities of an organizational network, etc. In some cases, data repository 210 can be further configured to enable retrieval and/or update and/or deletion of the data stored thereon. It is to be noted that in some cases, data repository 210 can be distributed. It is to be noted that in some cases, at least part of data repository 210 can be stored in on a cloud-based storage.

Cyber security system 200 further comprises processing circuitry 230. Processing circuitry 230 can be one or more processing units (e.g. central processing units), microprocessors, microcontrollers (e.g. microcontroller units (MCUs)) or any other computing devices or modules, including multiple and/or parallel and/or distributed processing units, which are adapted to independently or cooperatively process data for controlling relevant organizational cyber security system 200 resources and for enabling operations related to organizational cyber security system 200 resources.

The processing circuitry 230 comprises a top-down cyber-attack identification module 240.

Top-down cyber-attack identification module 240 can be configured to perform a top-down cyber-attack identification by identifying execution of one or more sequence of machine language instructions process, as further detailed herein, inter alia with reference to FIG. 3.

Top-down cyber-attack identification module 240 can be further configured to perform a top-down cyber-attack identification by identifying occurrence of one or more event types process, as further detailed herein, inter alia with reference to FIG. 4.

Turning to FIG. 3, there is shown a any flowchart illustrating one example of a sequence of operations carried out for a top-down cyber-attack identification by identifying execution of one or more sequence of machine language instructions process, in accordance with the presently disclosed subject matter.

According to certain examples of the presently disclosed subject matter, cyber security system 200 can be configured to perform a top-down cyber-attack identification by identifying execution of one or more sequence of machine language instructions process 300, e.g., utilizing the top-down cyber-attack identification module 240.

For this purpose, cyber security system 200 can be configured to obtain: (a) an attack-vector scenario, the attack-vector scenario comprising a sequence of cyber tactics, each of the cyber tactics being associated with one or more respective cyber techniques which are possible manifestations of the corresponding cyber tactic in the context of the attack-vector scenario, at least one cyber technique is associated with at least one sequence of machine language instructions that can execute on one or more processors of at least one entity of a plurality of entities of an organizational network, wherein execution of the at least one sequence of machine language instructions indicates implementation of the respective cyber technique, and (b) information about actual sequences of machine language instructions that executed on the one or more processors (block 310). Cyber security system 200 can obtain one or more attack-vector scenarios 110. The one or more attack-vector scenarios 110 can be obtained by the cyber security system 200 from various sources: cyber-attack simulators, research of cyber-attack scenarios executed on the organizational network or on other organizational networks, attack-vector scenarios 110 knowledge bases or any other known cyber-attack scenarios. The attack-vector scenarios 110 knowledge bases can be from general sources, that are external to an organization that cyber security system 200 is part of. The attack-vector scenarios 110 knowledge base can contain information of known attacks that the organization and/or other organization have endured. A non-limiting example of such a knowledge base is the MITRE ATT&CK framework. In some cases, the cyber security system 200 identifies new attack-vector scenarios 110 automatically as part of its operation within the organizational network.

The information about actual sequences of machine language instructions that are fetched and/or executed on processors of the one or more entities of the organizational network can include any sequence of machine language instructions that can execute on one or more processors of any asset of the organizational network. Example sequences can include: the sequence of machine language instructions required for the at least partial implementation of creation of a file on an endpoint of the organizational network, the sequence of machine language instructions required for the any at least partial implementation of creation of a process—for example creation of a log process with full command line permissions for the current and parent process, the sequence of machine language instructions required for the at least partial implementation of execution of a command—for example execution of a “dir” command utilizing a command line of an endpoint, the sequence of machine language instructions required for the at least partial implementation of replacement of a file—for example replacement of a “msfte.dll” DLL file within an endpoint, the sequence of machine language instructions required for the at least partial implementation of deletion of a file, the sequence of machine language instructions required for the at least partial implementation of termination of a process, the sequence of machine language instructions required for the at least partial implementation of change of a name of a file on a device, the sequence of machine language instructions required for the at least partial implementation of change of a name of a process, the sequence of machine language instructions required for the any at least partial implementation of loading of a driver, the sequence of machine language instructions required for the at least partial implementation of loading of a DLL, the sequence of machine language instructions required for the at least partial implementation of accessing a disk, the sequence of machine language instructions required for the at least partial implementation of opening of a network connection, the sequence of machine language instructions required for the at least partial implementation of changes to values of a registry, or any other sequence of machine language instructions required for realizing at least a partial implementation of an operation occurring on an asset of the organizational network.

The actual sequence of machine language instructions can include at least one normal sequence of machine language instructions that is not identified as an abnormal sequence of machine language instructions. Normal sequence of machine language instructions is sequence of machine language instructions that execute within assets of the organizational network as part of regular processes that takes place on one or more of the assets. Abnormal sequence of machine language instructions is sequence of machine language instructions that are not normal, are not part of the regular processes that take place on one or more of the assets. A normal sequence of machine language instructions can be for example a sequence of machine language instructions required for the at least partial implementation of enabling a user of an endpoint to log into the endpoint using his correct username and password. An abnormal sequence of machine language instructions required can be for example a sequence of machine language instructions required for the at least partial implementation of replacement of a system file on one of the endpoints.

The actual sequence of machine language instructions can include properties associated with the sequence, for example the sequence of machine language instructions required for process creation can include a property of the hash of the process image files. Another example of a parameter can be the signatures and hashes of loaded DLL as part of the loading of a DLL sequence. An additional example of sequence properties can be the type of access of accessing a disk sequence. Sequence properties can also include source process, IP addresses, port numbers, hostnames, date and time of the execution of the actual sequence of machine language instructions and port names for the network connection sequence. Another example of properties an include the registry value changed for the changes to values of a registry sequence.

A non-limiting example of a cyber-attack scenario can be the persistence attack-vector scenario 110 and its sequence of two cyber tactics: discovery cyber tactic and persistence cyber tactic, described herein, inter alia with reference to FIG. 1 and the information obtained can include, for example, the occurrence of an actual sequence of machine language instructions required for the at least partial implementation of is execution of a “dir” command and the occurrence of an actual sequence of machine language instructions required for the at least partial implementation of replacement of the “msfte.dll” DLL file.

It is to be noted that in some cases, the cyber security system 200 can be an Endpoint Detection and Response (EDR) system monitoring endpoints connected through the organizational network, a Security Information and Events Management (SIEM) system, or any other cyber security system. The endpoints monitored can be devices, firewalls, servers, IoT devices or any other asset of the organization. In some cases, cyber security system 200 performs the entire top-down cyber-attack identification by identifying execution of one or more sequence of machine language instructions process 300 on a given endpoint of the organizational network. In other cases, the top-down cyber-attack identification by identifying execution of one or more sequence of machine language instructions process 300 can collect the actual sequences of machine language instructions information from one or more endpoints of the organizational network and process the information in a central location or in a distributed manner or on one or more cloud computing platforms or in any other manner or combination thereof. In some cases, at least some of the information is obtained by an agent installed on the assets of the organizational network. In some cases, at least some of the information is retrieved by proactively querying one or more assets of the organizational network. For example, when cyber security system 200 lacks actual sequence of machine language instructions information for identifying the cyber techniques it can query an asset where the needed information can be found.

After obtaining the attack-vector scenarios 110 and the information, the cyber security system 200 can be further configured to identify, based on the information, the cyber techniques that occurred on the organizational network by matching the actual sequences of machine language instructions with the at least one sequence of machine language instructions associated with the cyber techniques, giving rise to implemented cyber techniques (block 320). Continuing our non-limiting example, cyber security system 200 identifies the occurrence of the file and directory discovery cyber technique as the sequence of machine language instructions required for the execution of a “dir” command has actually occurred on the organizational network and the occurrence of the hijack execution flow cyber technique as the sequence of machine language instructions required for the replacement of the “msfte.dll” DLL file has actually occurred on the organizational network. The file and directory discovery cyber technique and the hijack execution flow cyber technique are now both implemented cyber techniques.

The cyber security system 200 than alert a user of the cyber security system 200 of a potential cyber-attack upon determining that each of the cyber tactics forming the attack vector scenario, is associated with at least one of the implemented cyber techniques (block 330). It is noted that alerting the user of the potential cyber-attack is upon further determining that a causality connection exists between one or more of the implemented cyber techniques associated with each given cyber tactic of the cyber tactics and one or more of the implemented cyber techniques associated with a subsequent cyber tactic subsequent to the given cyber tactic, if any. Continuing the non-limiting example of the persistence attack-vector scenario 110 and its sequence of two cyber tactics: discovery cyber tactic and persistence cyber tactic, the occurrence of an actual sequence of machine language instructions required for the at least partial implementation of execution of a “dir” command, is an indication of implementation of the file and directory discovery cyber technique, which means that the discovery cyber tactic has occurred and the occurrence of an actual sequence of machine language instructions required for the at least partial implementation of replacement of the “msfte.dll” DLL file, is an indication of implementation of the hijack execution flow cyber technique, which means that the persistence cyber tactic has occurred. As both tactics in the sequence of the persistence attack-vector scenario 110 have occurred, we can optionally check for a common property connection between the actual sequences. In our non-limiting example, a rule-set is used to analyses the relevant actual sequences of machine language instructions and their properties to find that there is a casual connection, for example the date and time of both actual sequences are within a predefined time window, so there is an indication of occurrence of the persistence attack-vector scenario 110 within the attacked organizational network.

After alerting the user, the cyber security system 200 can be optionally further configured to predict, based on: (a) the attack-vector scenario 110, (b) the implemented cyber techniques, and (c) the previously identified implemented cyber techniques, a next step cyber tactic of the cyber tactics (block 340). The prediction made by cyber security system 200 can be based on the parts of the sequence of cyber tactics of the attack-vector scenario 110 that have already been identified in block 320 and on the parts that have not yet been identified. The prediction can be based on: machine learning, one or more rule sets, experts' knowledgebase or any other method to identify common properties between two or more cyber techniques. In a non-limiting example of using a rule set for the prediction, the identification of the occurrence of a given cyber tactic within the organizational network can be used by cyber security system 200 to predict that the next step cyber tactic is a subsequent cyber tactic, subsequent to the given cyber tactic within the sequence of cyber tactics of the attack-vector scenario 110. For example, in the context of the persistence attack-vector scenario 110, identifying the occurrence of the file and directory discovery cyber technique, but not identifying an occurrence of the hijack execution flow cyber technique can lead to the prediction that an adversary will try to implement the hijack execution flow cyber technique. The prediction can optionally include the properties of the actual sequences of machine language instructions associated with the predicted next step of the adversary.

In some cases, the alert requirements further include that at least two of the implemented cyber techniques meet a validation rule validating at least a part of the attack-vector scenario. The validation rule can be based on expert knowledge of how an attack-vector scenario 110 occurs within organizational networks. In some cases, cyber security system 200 can automatically deduce one or more validation rules from the sequences of machine language instructions, for example, by using machine learning techniques. In some cases, the validation rules are specific to the attack-vector scenario 110. The validation is based on one or more properties of each of the at least two of the implemented cyber techniques. A non-limiting example of a validation rule can be, continuing our previous example, a validation rule checking that the directory viewed in the file and directory discovery cyber technique is the same directory where the sequence of machine language instructions for implementing at least part of the replacement of the “msfte.dll” DLL file occurred.

In some cases, cyber security system 200 can be optionally further configured to perform a prevention action to prevent the next step cyber tactic (block 350). It is noted that in some cases, cyber security system 200 can predict one or more cyber techniques associated with the next step cyber tactic that will be used by the adversary and in some cases, even the properties of the actual sequences of machine language instructions associated with the predicted next step of the adversary. The prevention action can optionally rely on these predictions. Some non-limiting examples of a prevention action can include one or more of: (a) report the next step cyber tactic to the user of the cyber security system, (b) simulate the next step cyber tactic, (c) implement one or more honeypots within one or more entities of the organizational network wherein sequences of machine language instructions associated with the next step cyber tactic can occur, or (d) any other action of actions that can be done to prevent the next step cyber tactic.

It is to be noted that the information can be obtained periodically or continuously by cyber security system 200 and that the identify step (block 320), the alert step (block 330), the predict step (block 340) and the prevention action step (block 350) can be performed periodically or continuously while maintaining previously identified implemented cyber techniques. For example, the information of the occurrence of the actual sequence of machine language instructions required for the at least partial implementation of execution of a “dir” command can be obtained during a first period, maintained by cyber security system 200, for example, by storing the actual sequence in data repository 210 and the information of the occurrence of the actual sequence of machine language instructions required for the at least partial implementation of replacement of the “msfte.dll” DLL file can be obtained only at a later period. cyber security system 200 will be able to use both pieces of information to identify the occurrence of the file and directory discovery cyber technique and the occurrence of the hijack execution flow cyber technique and to alert the user of a potential cyber-attack of the persistence attack-vector scenario 110.

It is to be noted that, with reference to FIG. 3, some of the blocks can be integrated into a consolidated block or can be broken down to a few blocks and/or other blocks may be added. Furthermore, in some cases, the blocks can be performed in a different order than described. It is to be further noted that some of the blocks are optional (for example: blocks 340 and 350). It should be also noted that whilst the flow diagram is described also with reference to the system elements that realizes them, this is by no means binding, and the blocks can be performed by elements other than those described herein.

Turning to FIG. 4, there is shown a flowchart illustrating one example of a sequence of operations carried out for a top-down cyber-attack identification by identifying occurrence of one or more event types process, in accordance with the presently disclosed subject matter.

According to certain examples of the presently disclosed subject matter, cyber security system 200 can be configured to perform a top-down cyber-attack identification by identifying occurrence of one or more event types process 400, e.g., utilizing the top-down cyber-attack identification module 240.

For this purpose, cyber security system 200 can be configured to obtain: (a) an attack-vector scenario 110, the attack-vector scenario 110 comprising a sequence of cyber tactics (e.g., cyber tactic A 120-a, cyber tactic B 120-b, . . . , cyber tactic N 120-n), each of the cyber tactics being associated with one or more respective cyber techniques (e.g., cyber technique AA 130-aa, cyber technique AB 130-ab, . . . , cyber technique AN 130-an, cyber technique BA 130-ba, cyber technique BB 130-bb, . . . , cyber technique BN 130-bn, cyber technique AN 130-an, cyber technique NA 130-na, cyber technique NB 130-nb . . . cyber technique NN 130-nn) which are possible manifestations of the corresponding cyber tactic in the context of the attack-vector scenario 110, each cyber technique is associated with a corresponding event type of a plurality of event types that can occur on one or more entities of an organizational network, wherein occurrence of an actual event of the respective event type indicates implementation of the respective cyber technique, and (b) information about actual events that occurred on the one or more entities of the organizational network, wherein each of the actual events is associated with a respective actual event type (block 410). Cyber security system 200 can obtain one or more attack-vector scenarios 110. The one or more attack-vector scenarios 110 can be obtained by the cyber security system 200 from various sources: cyber-attack simulators, research of cyber-attack scenarios executed on the organizational network or on other organizational networks, attack-vector scenarios 110 knowledge bases or any other known cyber-attack scenarios. The attack-vector scenarios 110 knowledge bases can be from general sources, that are external to an organization that cyber security system 200 is part of. The attack-vector scenarios 110 knowledge base can contain information of known attacks that the organization and/or other organization have endured. A non-limiting example of such a knowledge base is the MITRE ATT&CK framework. In some cases, the cyber security system 200 identifies new attack-vector scenarios 110 automatically as part of its operation within the organizational network.

The information about actual events that occurred on the one or more entities of the organizational network can include any event that can occur on any asset of the organizational network. Example events can include: creation of a file on an endpoint of the organizational network, creation of a process—for example creation of a log process with full command line permissions for the current and parent process, execution of a command—for example execution of a “dir” command utilizing a command line of an endpoint, replacement of a file—for example replacement of a “msfte.dll” DLL file within an endpoint, deletion of a file, termination of a process, change of a name of a file on a device, change of a name of a process, loading of a driver, loading of a DLL, accessing a disk, opening of a network connection, changes to values of a registry, or any other event occurring on an asset of the organizational network.

The actual events include at least one normal event that is not identified as abnormal. Normal events are events that occur within assets of the organizational network as part of regular processes that take place on one or more of the assets. Abnormal events are events that are not normal, are not part of the regular processes that take place on one or more of the assets. A normal event can be for example a user of an endpoint logging into the endpoint using his correct username and password. An abnormal event can be for example a replacement of a system file on one of the endpoints.

The actual events can include properties associated with the event, for example the event of process creation can include a property of the hash of the process image files. Another example of a parameter can be the signatures and hashes of loaded DLL as part of the loading of a DLL event. An additional example of event properties can be the type of access of accessing a disk event. Event properties can also include source process, IP addresses, port numbers, hostnames, date and time of the actual event and port names for the network connection event. Another example of properties an include the registry value changed for the changes to values of a registry event.

A non-limiting example of a cyber-attack scenario can be the persistence attack-vector scenario 110 and its sequence of two cyber tactics: discovery cyber tactic and persistence cyber tactic, described herein, inter alia with reference to FIG. 1 and the information obtained can include, for example, the occurrence of an actual event of execution of a “dir” command and the occurrence of an actual event of replacement of the “msfte.dll” DLL file.

It is to be noted that in some cases, the cyber security system 200 can be an Endpoint Detection and Response (EDR) system monitoring endpoints connected through the organizational network, a Security Information and Events Management (SIEM) system, or any other cyber security system. The endpoints monitored can be devices, firewalls, servers, IoT devices or any other asset of the organization. In some cases, cyber security system 200 performs the entire top-down cyber-attack identification by identifying occurrence of one or more event types process 400 on a given endpoint of the organizational network. In other cases, the top-down cyber-attack identification by identifying occurrence of one or more event types process 400 can collect the actual events information from one or more endpoints of the organizational network and process the information in a central location or in a distributed manner or on one or more cloud computing platforms or in any other manner or combination thereof. In some cases, at least some of the information is obtained by an agent installed on the assets of the organizational network. In some cases, at least some of the information is retrieved by proactively querying one or more assets of the organizational network. For example, when cyber security system 200 lacks actual events information for identifying the cyber techniques it can query an asset where the needed information can be found.

After obtaining the attack-vector scenarios 110 and the information, the cyber security system 200 can be further configured to identify, based on the information, the cyber techniques that occurred on the organizational network by matching the actual event types with the event types associated with the cyber techniques, giving rise to implemented cyber techniques (block 420). Continuing our non-limiting example, cyber security system 200 identifies the occurrence of the file and directory discovery cyber technique as the event of execution of a “dir” command has actually occurred on the organizational network and the occurrence of the hijack execution flow cyber technique as the event of replacement of the “msfte.dll” DLL file has actually occurred on the organizational network. The file and directory discovery cyber technique and the hijack execution flow cyber technique are now both implemented cyber techniques.

The cyber security system 200 than alert a user of the cyber security system 200 of a potential cyber-attack upon determining that alert requirements being met, the alert requirements including that: (a) each of the cyber tactics forming the attack vector scenario, is associated with at least one of the implemented cyber techniques, and (b) each pair of implemented cyber techniques associated with a pair of subsequent cyber tactics is associated with a respective common property (block 430). Continuing the non-limiting example of the persistence attack-vector scenario 110 and its sequence of two cyber tactics: discovery cyber tactic and persistence cyber tactic, the occurrence of the actual event of execution of a “dir” command, is an indication of implementation of the file and directory discovery cyber technique, which means that the discovery cyber tactic has occurred and the occurrence of an actual event of replacement of the “msfte.dll” DLL file, is an indication of implementation of the hijack execution flow cyber technique, which means that the persistence cyber tactic has occurred. As both tactics in the sequence of the persistence attack-vector scenario 110 have occurred, we can optionally check for a common property connection between the actual events. In our non-limiting example, a rule-set is used to analyses the relevant actual events and their properties to find that there is a casual connection, for example the date and time of both actual events are within a predefined time window, so there is an indication of occurrence of the persistence attack-vector scenario 110 within the attacked organizational network.

After alerting the user, the cyber security system 200 can be optionally further configured to predict, based on: (a) the attack-vector scenario 110, (b) the implemented cyber techniques, and (c) the previously identified implemented cyber techniques, a next step cyber tactic of the cyber tactics (block 340). The prediction made by cyber security system 200 can be based on the parts of the sequence of cyber tactics of the attack-vector scenario 110 that have already been identified in block 320 and on the parts that have not yet been identified. The prediction can be based on: machine learning, one or more rule sets, experts' knowledgebase or any other method to identify common properties between two or more cyber techniques. In a non-limiting example of using a rule set for the prediction, the identification of the occurrence of a given cyber tactic within the organizational network can be used by cyber security system 200 to predict that the next step cyber tactic is a subsequent cyber tactic, subsequent to the given cyber tactic within the sequence of cyber tactics of the attack-vector scenario 110. For example, in the context of the persistence attack-vector scenario 110, identifying the occurrence of the file and directory discovery cyber technique, but not identifying an occurrence of the hijack execution flow cyber technique can lead to the prediction that an adversary will try to implement the hijack execution flow cyber technique. The prediction can optionally include the properties of the actual events associated with the predicted next step of the adversary.

In some cases, the alert requirements further include that at least two of the implemented cyber techniques meet a validation rule validating at least a part of the attack-vector scenario. The validation rule can be based on expert knowledge of how an attack-vector scenario 110 occurs within organizational networks. In some cases, cyber security system 200 can automatically deduce one or more validation rules from the events, for example, by using machine learning techniques. In some cases, the validation rules are specific to the attack-vector scenario 110. The validation is based on one or more properties of each of the at least two of the implemented cyber techniques. A non-limiting example of a validation rule can be, continuing our previous example, a validation rule checking that the directory viewed in the file and directory discovery cyber technique is the same directory where the event of replacement of the “msfte.dll” DLL file occurred.

In some cases, cyber security system 200 can be optionally further configured to perform a prevention action to prevent the next step cyber tactic (block 450). It is noted that in some cases, cyber security system 200 can predict one or more cyber techniques associated with the next step cyber tactic that will be used by the adversary and in some cases, even the properties of the actual events associated with the predicted next step of the adversary. The prevention action can optionally rely on these predictions. Some non-limiting examples of a prevention action can include one or more of: (a) report the next step cyber tactic to the user of the cyber security system, (b) simulate the next step cyber tactic, (c) implement one or more honeypots within one or more entities of the organizational network wherein events associated with the next step cyber tactic can occur, or (d) any other action of actions that can be done to prevent the next step cyber tactic.

It is to be noted that the information can be obtained periodically or continuously by cyber security system 200 and that the identify step (block 420), the alert step (block 430), the predict step (block 440) and the prevention action step (block 450) can be performed periodically or continuously while maintaining previously identified implemented cyber techniques. For example, the information of the occurrence of the actual event of execution of a “dir” command can be obtained during a first period, maintained by cyber security system 200, for example, by storing the actual event in data repository 210 and the information of the occurrence of the actual event of replacement of the “msfte.dll” DLL file can be obtained only at a later period. cyber security system 200 will be able to use both pieces of information to identify the occurrence of the file and directory discovery cyber technique and the occurrence of the hijack execution flow cyber technique and to alert the user of a potential cyber-attack of the persistence attack-vector scenario 110.

It is to be noted that, with reference to FIG. 4, some of the blocks can be integrated into a consolidated block or can be broken down to a few blocks and/or other blocks may be added. Furthermore, in some cases, the blocks can be performed in a different order than described. It is to be further noted that some of the blocks are optional (for example: blocks 440 and 450). It should be also noted that whilst the flow diagram is described also with reference to the system elements that realizes them, this is by no means binding, and the blocks can be performed by elements other than those described herein.

It is to be understood that the presently disclosed subject matter is not limited in its application to the details set forth in the description contained herein or illustrated in the drawings. The presently disclosed subject matter is capable of other embodiments and of being practiced and carried out in various ways. Hence, it is to be understood that the phraseology and terminology employed herein are for the purpose of description and should not be regarded as limiting. As such, those skilled in the art will appreciate that the conception upon which this disclosure is based may readily be utilized as a basis for designing other structures, methods, and systems for carrying out the several purposes of the present presently disclosed subject matter.

It will also be understood that the system according to the presently disclosed subject matter can be implemented, at least partly, as a suitably programmed computer. Likewise, the presently disclosed subject matter contemplates a computer program being readable by a computer for executing the disclosed method. The presently disclosed subject matter further contemplates a machine-readable memory tangibly embodying a program of instructions executable by the machine for executing the disclosed method.

1. A cyber security system, the cyber security system comprising a processing circuitry configured to:
obtain: (a) an attack-vector scenario, the attack-vector scenario comprising a sequence of cyber tactics, each of the cyber tactics being associated with one or more respective cyber techniques which are possible manifestations of the corresponding cyber tactic in the context of the attack-vector scenario, at least one cyber technique is associated with at least one sequence of machine language instructions that can execute on one or more processors of at least one entity of a plurality of entities of an organizational network, wherein execution of the at least one sequence of machine language instructions indicates implementation of the respective cyber technique, and (b) information about actual sequences of machine language instructions that executed on the one or more processors;
identify, based on the information, the cyber techniques that occurred on the organizational network by matching the actual sequences of machine language instructions with the at least one sequence of machine language instructions associated with the cyber techniques, giving rise to implemented cyber techniques; and
alert a user of the cyber security system of a potential cyber-attack upon determining that each of the cyber tactics forming the attack vector scenario, is associated with at least one of the implemented cyber techniques.

2. The cyber security system of claim 1, wherein alerting the user of the potential cyber-attack is upon further determining that a causality connection exists between one or more of the implemented cyber techniques associated with each given cyber tactic of the cyber tactics and one or more of the implemented cyber techniques associated with a subsequent cyber tactic subsequent to the given cyber tactic, if any.

3. The cyber security system of claim 1, wherein the information about the actual sequences of machine language instructions is obtained by a trapping mechanism, capable of retrieving machine language instructions from an instruction unit, storing fetched machine learning instruction for at least one processor of the processors.

4. The cyber security system of claim 1, wherein: (a) at least one machine language instruction of the sequence of machine language instructions comprises one or more first opcodes, and (b) the identification of the implemented cyber techniques is based on matching the opcodes comprised in the actual sequences of machine language instructions with second opcodes comprised in the at least one sequence of machine language instructions.

5. The cyber security system of claim 1, wherein the at least one sequence of machine language instructions is at least a partial translation of code realizing the corresponding cyber technique into machine langue instructions.

6. The cyber security system of claim 1, wherein the at least one sequence of machine language instructions includes one or more suspicious machine langue instructions, being machine learning instructions being a translation of suspicious code.

7. The cyber security system of claim 1, wherein: (a) at least one cyber technique is associated with a corresponding event type of a plurality of event types that can occur on the one or more entities of the organizational network, wherein occurrence of an actual event of the respective event type indicates implementation of the respective cyber technique, (b) the information further includes actual events that occurred on the one or more entities of the organizational network, wherein each of the actual events is associated with a respective actual event type, and (c) the identification of the implemented cyber techniques is further based on matching the actual event types with the event types associated with the cyber techniques, giving rise to implemented cyber techniques.

8. The cyber security system of claim 1, wherein the information is obtained periodically or continuously and wherein the identify and the alert are performed periodically or continuously while maintaining previously identified implemented cyber techniques.

9. The cyber security system of claim 8, wherein the processing circuitry is further configured to:
predict, based on: (a) the attack-vector scenario, (b) the implemented cyber techniques, and (c) the previously identified implemented cyber techniques, a next step cyber tactic of the cyber tactics; and
perform a prevention action to prevent the next step cyber tactic.

10. The cyber security system of claim 9, wherein the prevention action is one or more of: (a) report the next step cyber tactic to the user of the cyber security system, (b) simulate the next step cyber tactic, or (c) implement one or more honeypots within one or more entities of the organizational network wherein events associated with the next step cyber tactic can occur.

11. (canceled)

12. (canceled)

13. (canceled)

14. A method comprising:
obtaining, by a processing circuitry: (a) an attack-vector scenario, the attack-vector scenario comprising a sequence of cyber tactics, each of the cyber tactics being associated with one or more respective cyber techniques which are possible manifestations of the corresponding cyber tactic in the context of the attack-vector scenario, at least one cyber technique is associated with at least one sequence of machine language instructions that can execute on one or more processors of at least one entity of a plurality of entities of an organizational network, wherein execution of the at least one sequence of machine language instructions indicates implementation of the respective cyber technique, and (b) information about actual sequences of machine language instructions that executed on the one or more processors;
identifying, by the processing circuitry, based on the information, the cyber techniques that occurred on the organizational network by matching the actual sequences of machine language instructions with the at least one sequence of machine language instructions associated with the cyber techniques, giving rise to implemented cyber techniques; and
alerting, by the processing circuitry, a user of the cyber security system of a potential cyber-attack upon determining that each of the cyber tactics forming the attack vector scenario, is associated with at least one of the implemented cyber techniques.

15. The method of claim 14, wherein alerting the user of the potential cyber-attack is upon further determining that a causality connection exists between one or more of the implemented cyber techniques associated with each given cyber tactic of the cyber tactics and one or more of the implemented cyber techniques associated with a subsequent cyber tactic subsequent to the given cyber tactic, if any.

16. The method of claim 14, wherein the information about the actual sequences of machine language instructions is obtained by a trapping mechanism, capable of retrieving machine language instructions from an instruction unit, storing fetched machine learning instruction for at least one processor of the processors.

17. The method of claim 14, wherein: (a) at least one machine language instruction of the sequence of machine language instructions comprises one or more first opcodes, and (b) the identification of the implemented cyber techniques is based on matching the opcodes comprised in the actual sequences of machine language instructions with second opcodes comprised in the at least one sequence of machine language instructions.

18. (canceled)

19. The method of claim 14, wherein the at least one sequence of machine language instructions includes one or more suspicious machine langue instructions, being machine learning instructions being a translation of suspicious code.

20. The method of claim 14, wherein: (a) at least one cyber technique is associated with a corresponding event type of a plurality of event types that can occur on the one or more entities of the organizational network, wherein occurrence of an actual event of the respective event type indicates implementation of the respective cyber technique, (b) the information further includes actual events that occurred on the one or more entities of the organizational network, wherein each of the actual events is associated with a respective actual event type, and (c) the identification of the implemented cyber techniques is further based on matching the actual event types with the event types associated with the cyber techniques, giving rise to implemented cyber techniques.

21. The method of claim 14, wherein the information is obtained periodically or continuously and wherein the identify and the alert are performed periodically or continuously while maintaining previously identified implemented cyber techniques.

22. The method of claim 21, further comprising:
predicting, by the processing circuitry, based on: (a) the attack-vector scenario, (b) the implemented cyber techniques, and (c) the previously identified implemented cyber techniques, a next step cyber tactic of the cyber tactics; and
performing, by the processing circuitry, a prevention action to prevent the next step cyber tactic.

23. The method of claim 22, wherein the prevention action is one or more of: (a) report the next step cyber tactic to the user of the cyber security system, (b) simulate the next step cyber tactic, or (c) implement one or more honeypots within one or more entities of the organizational network wherein events associated with the next step cyber tactic can occur.

24. (canceled)

25. (canceled)

26. (canceled)

27. A non-transitory computer readable storage medium having computer readable program code embodied therewith, the computer readable program code, executable by at least one processing circuitry of a computer to perform a method of:
obtaining, by a processing circuitry: (a) an attack-vector scenario, the attack-vector scenario comprising a sequence of cyber tactics, each of the cyber tactics being associated with one or more respective cyber techniques which are possible manifestations of the corresponding cyber tactic in the context of the attack-vector scenario, at least one cyber technique is associated with at least one sequence of machine language instructions that can execute on one or more processors of at least one entity of a plurality of entities of an organizational network, wherein execution of the at least one sequence of machine language instructions indicates implementation of the respective cyber technique, and (b) information about actual sequences of machine language instructions that executed on the one or more processors;
identifying, by the processing circuitry, based on the information, the cyber techniques that occurred on the organizational network by matching the actual sequences of machine language instructions with the at least one sequence of machine language instructions associated with the cyber techniques, giving rise to implemented cyber techniques; and
alerting, by the processing circuitry, a user of the cyber security system of a potential cyber-attack upon determining that each of the cyber tactics forming the attack vector scenario, is associated with at least one of the implemented cyber techniques.
